(19) United States
(12) Patent Application Publication
(10) Pub. No.: US 2021/0089886 A1
(43) Pub. Date: Mar. 25, 2021

(54) METHOD FOR PROCESSING DATA BASED ON NEURAL NETWORKS TRAINED BY DIFFERENT METHODS AND DEVICE APPLYING METHOD

(71) Applicant: HON HAI PRECISION INDUSTRY CO., LTD., New Taipei (TW)

(72) Inventors: TZU-CHEN LIN, New Taipei (TW); TUNG-TSO TSAI, New Taipei (TW); GUO-CHIN SUN, New Taipei (TW); CHIN-PIN KUO, New Taipei (TW); WAN-JHEN LEE, New Taipei (TW)

(21) Appl. No.: 16/826,437

(22) Filed: Mar. 23, 2020

(30) Foreign Application Priority Data
Sep. 24, 2019 (CN) 201910907524.1

(51) Int. Cl. G06N 3/08; G06N 3/04

(52) U.S. Cl. CPC G06N 3/08; G06N 3/04

(57) ABSTRACT

A method for processing data based on a neural network trained by different methods includes: dividing sample data into a training set and a test set; training a predetermined neural network to obtain a first detection model based on the training set; testing the first detection model based on the test set to count a first precision rate; cleaning the training set and the test set according to selected cleaning method; adjusting the first detection model by a predetermined rule and training adjusted first detection model based on cleaned training set to obtain a second detection model; testing the second detection model based on cleaned test set to count a second precision rate; selecting the first detection model or the second detection model as a final detection model based on a comparison between the first precision rate and the second precision rate.

### FIELD

The subject matter herein generally relates to data processing.

### BACKGROUND

Accurate data analysis is required as machine learning technology is being developed and applied to increasing numbers of real life situations. In real life situations, suitable models can be designed and trained by correlations between sample data and simple labels. However, the sample data collected may be affected by factors such as the environment during the date collection processes, inherent defects in the data, and human errors. Hence, the accuracy of the model will also be affected.

Thus, there is a room for improvement.

### BRIEF DESCRIPTION OF THE DRAWINGS

Implementations of the present disclosure will now be described, by way of embodiments, with reference to the attached figures.

FIG. 1 is a block diagram of an embodiment of a data processing device.

FIG. 2 is a block diagram of an embodiment of a data processing system of the data processing device of FIG. 0.1.

FIGS. 3 and 4 are flow diagrams of an embodiment of a data processing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

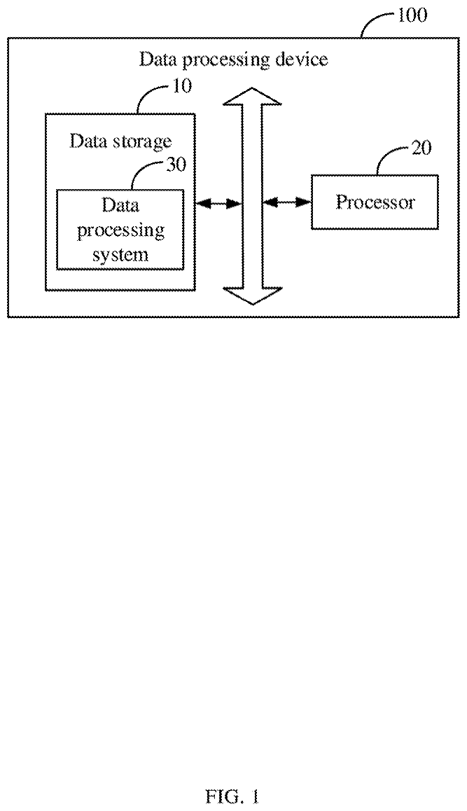

FIG. 1 illustrates a data processing device 100 in accordance with an embodiment. The data processing device 100 can comprise at least one data storage 10, at least one processor 20, and a data processing system 30.

In one embodiment, the data processing device 100 can be a computer or a server. The data processing device 100 can further comprise a display device, a network access device, and communication buses.

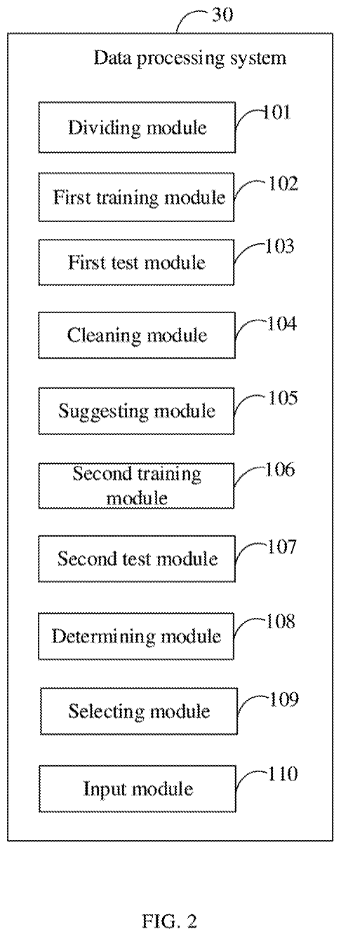

FIG. 2 illustrates the data processing system 30 comprising a plurality of modules, such as a dividing module 101, a first training module 102, a first test module 103, a cleaning module 104, and a suggesting module 105, a second training module 106, a second test module 107, a determining module 108, a selecting module 109, and an input module 110. The modules 101-110 may comprise one or more software programs in the form of computerized codes stored in the data storage 10. The computerized codes may include instructions that can be executed by the processor 20 to provide functions for the modules 101-110.

In one embodiment, the data storage 10 can be in the data processing device 100, or can be a separate external memory card, such as an SM card (Smart Media Card), an SD card (Secure Digital Card), or the like. The data storage 10 can include various types of non-transitory computer-readable storage mediums. For example, the data storage 10 can be an internal storage system, such as a flash memory, a random access memory (RAM) for temporary storage of information, and/or a read-only memory (ROM) for permanent storage of information. The data storage 10 can also be an external storage system, such as a hard disk, a storage card, or a data storage medium. The processor 20 can be a central processing unit (CPU), a microprocessor, or other data processor chip that performs functions of the data processing device 100.

The dividing module 101 divides sample data into a training set and a test set.

In one embodiment, the sample data can be selected according to actual data processing requirement. For example, when a model of the data processing device 100 is face recognition, the sample data can be multiple facial images. When the model of the data processing device 100 is identification of an object, the sample data can be multiple images comprising the object. The dividing module 101 can divide the sample data into the training set and the test set according to a predetermined ratio. Amount of data for the training set is greater than amount of data for the test set. The training set is configured to train the model, and the test set is configured to test a performance of the model.

For example, the dividing module 101 applies eighty percent of the sample data into the training set and applies twenty percent of the sample data into the test set. Data for the training set and the test set is randomly extracted from the sample data.

The first training module 102 trains a predetermined neural network to obtain a first detection model based on the training set.

In one embodiment, the predetermined neural network can be a convolutional neural network or a deep neural network. The first training module 102 can train model parameters of the predetermined neural network to obtain the first detection model based on the training set.

The first test module 103 tests the first detection model based on the test set and counts a first precision rate based on testing of the first detection model.

In one embodiment, when the first detection model is trained by the first training module 102, the first test module 103 can test the first detection model and count the first precision rate based on testing of the first detection model. For example, each data of the test set is inputted to the first detection model, the first detection model can output a test result, and the first test module 103 can determine statistical correctness of the test results of the first detection mode to count the first precision rate of the first detection model.

The cleaning module 104 cleans the training set and the test set according to one or more selected cleaning methods.

In one embodiment, the data processing device 100 can comprise a data cleaning library and the data cleaning library can comprise a plurality of cleaning methods. The one or more selected cleaning methods can be selected or confirmed from the data cleaning library. The cleaning module 104 can obtain one or more cleaning methods which are selected from the data cleaning library, and clean the training set and clean the test set according to the one or more selected cleaning methods. For example, the one or more cleaning methods can be selected by a user.

In one embodiment, data cleaning can refer to perform predetermined processing on the sample data. For example, the sample data may be multiple sample images, and the one or more selected cleaning methods can be selected from the group consisting of: image feature extracting (edge detection algorithm), background removal, noise suppression, and smoothing.

In one embodiment, the data cleaning library can comprise a plurality of data cleaning units, each data cleaning unit corresponds to one data type, and each data cleaning unit can comprise one or more cleaning methods.

The suggesting module 105 obtains a data type corresponding to the sample data and outputs a selection suggestion of the data cleaning units based on the data type corresponding to the sample data.

In one embodiment, the sample data can be added with a type tag. The suggesting module 105 can obtain the type tag of the sample data and output the selection suggestion of the data cleaning units based on the type tag of the sample data. The selection suggestion can be outputted in a form of a prompt box. The selection suggestion can be a suggestion label added in the suggested data cleaning unit.

For example, when the data type corresponding to the sample data is image data, the suggesting module 105 can output a selection suggestion of a data cleaning unit that can process image data. When the data type corresponding to the sample data is a text data, the suggesting module 105 can output a selection suggestion of a data cleaning unit that can process data in the form of text.

In one embodiment, the suggesting module 105 can obtain cleaning methods of the data type recorded in a historical cleaning record, and define multiple cleaning methods that have been most often selected as a predetermined number in the historical cleaning record as suggested cleaning methods. For example, the data type corresponding to the sample data is the image data, the predetermined number is five. The suggesting module 105 obtains selection time with respect to image cleaning method recorded in the historical cleaning record, and defines five cleaning methods that represent the five most preferred cleaning methods. Then, the user can further select one or more cleaning methods from the five topmost cleaning methods to clean the image data.

The second training module 106 adjusts the first detection model by a predetermined rule and trains adjusted first detection model based on cleaned training set to obtain a second detection model.

In one embodiment, the second training module 106 can adjust a model parameter of the first detection model by the predetermined rule. The model parameter can comprise a number of hidden layers of the first detection model and/or a number of nerve cells of each hidden layer. The second training module 106 can train the adjusted first detection model (the first detection model that has been adjusted) based on the cleaned training set (the training set that has been cleaned) to obtain the second detection model. For example, the second training module 106 adjusting the first detection model by the predetermined rule can be removing the last fully connected layer of the first detection model.

The second test module 107 tests the second detection model based on cleaned test set and count a second precision rate based on testing of the second detection model.

In one embodiment, when data of each cleaned test set (the test set that has been cleaned) is inputted to the second detection model, the second detection model can output a test result, and the second test module 107 can determine statistical correctness of the test results of the second detection mode to count the second precision rate of the second detection model.

The determining module 108 determines whether the first precision rate is greater than the second precision rate.

In one embodiment, when the first precision rate and the second precision rate are assessed, the determining module 108 compares the first precision rate with the second precision rate to determine whether the first precision rate is greater than the second precision rate.

The selecting module 109 selects the first detection model as a final detection model if the first precision rate is greater than the second precision rate, and selects the second detection model as the final detection model if the second precision rate is greater than the first precision rate.

In one embodiment, if the first precision rate is greater than the second precision rate, so indicating that an effect of the first detection model is better than an effect of the second detection model, the selecting module 109 selects the first detection model as the final detection model. That is, the model of the data processing device 100 is suitable for training by original sample data. If the second precision rate is greater than the first precision rate, so indicating that the effect of the second detection model is better than the effect of the first detection model, and the selecting module 109 selects the second detection model as the final detection model. That is, the model of the data processing device 100 is suitable for training by cleaned sample data.

The input module 110 inputs detection data into the final detection model to obtain a detected result of the detection data.

In one embodiment, when the final detection model is trained, the input module 110 inputs the detection data into the final detection model, and the final detection model can output the detected result of the detection data. For example, the detection data is a facial image captured in a current time, the input module 110 inputs the facial image into the final detection model, and the final detection model can output a face recognition result of the facial image.

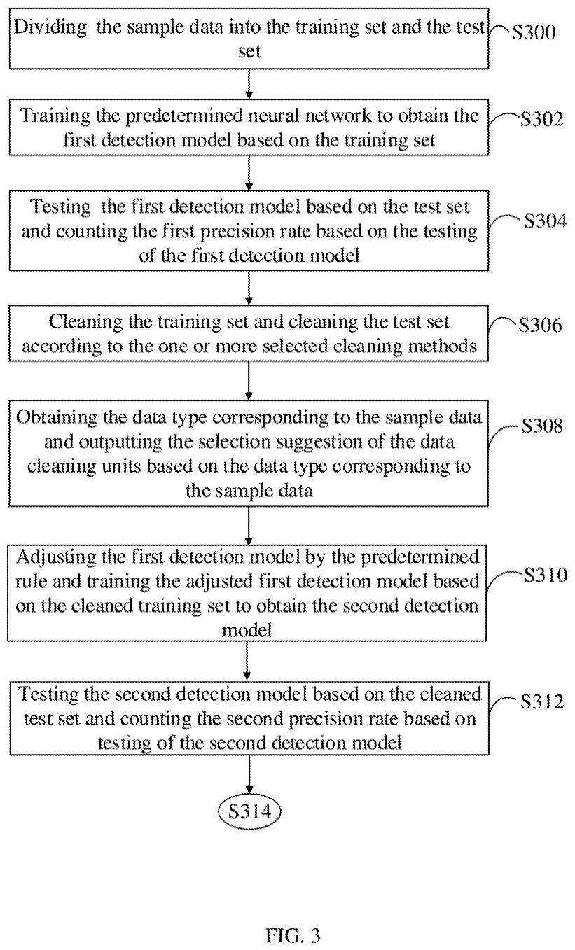

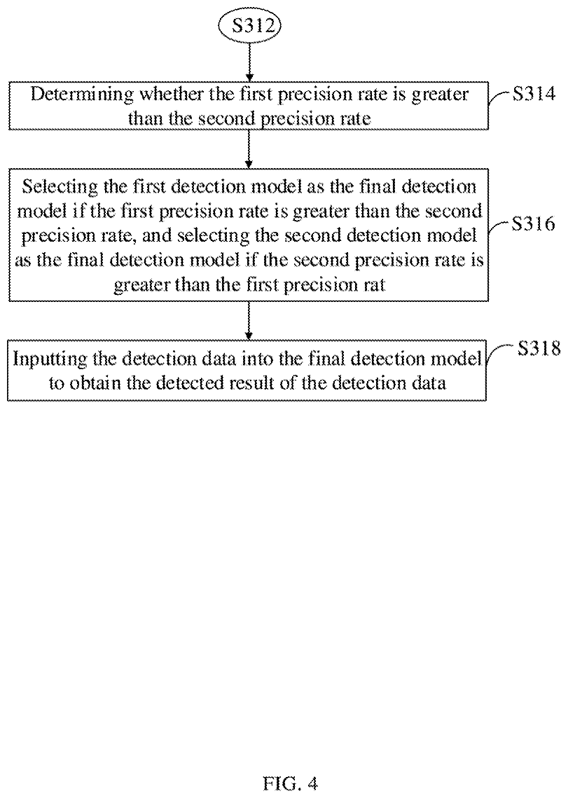

FIGS. 3 and 4 illustrate one exemplary embodiment of a data processing method. The flowchart presents an exemplary embodiment of the method. The exemplary method is provided by way of example, as there are a variety of ways to carry out the method. The method described below can be carried out using the configurations illustrated in FIG. 2, for example, and various elements of these figures are referenced in explaining the example method. Each block shown in FIGS. 3 and 4 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block S300.

In block S300, the dividing module 101 divides the sample data into the training set and the test set.

In block S302, the first training module 102 trains the predetermined neural network to obtain the first detection model based on the training set.

In block S304, the first test module 103 tests the first detection model based on the test set and counts the first precision rate based on the testing of the first detection model.

In block S306, the cleaning module 104 cleans the training set and cleans the test set according to the one or more selected cleaning methods.

In block S308, the suggesting module 105 obtains the data type corresponding to the sample data and outputs the selection suggestion of the data cleaning units based on the data type corresponding to the sample data.

In block S310, the second training module 106 adjusts the first detection model by the predetermined rule and trains the adjusted first detection model based on the cleaned training set to obtain the second detection model.

In block S312, the second test module 107 tests the second detection model based on the cleaned test set and counts the second precision rate based on testing of the second detection model.

In block S314, the determining module 108 determines whether the first precision rate is greater than the second precision rate.

In block S316, the selecting module 109 selects the first detection model as the final detection model if the first precision rate is greater than the second precision rate, and selects the second detection model as the final detection model if the second precision rate is greater than the first precision rat.

In block S318, the input module 110 inputs the detection data into the final detection model to obtain the detected result of the detection data.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A data processing method, the method comprising:
dividing sample data into a training set and a test set;
training a predetermined neural network to obtain a first detection model based on the training set;
testing the first detection model based on the test set and counting a first precision rate based on the testing of the first detection model;
cleaning the training set and cleaning the test set according to one or more selected cleaning methods;
adjusting the first detection model by a predetermined rule and training the first detection model that has been adjusted based on the training set that has been cleaned to obtain a second detection model;
testing the second detection model based on the test set that has been cleaned and counting a second precision rate based on the testing of the second detection model;
determining whether the first precision rate is greater than the second precision rate, wherein
the first detection model is selected as a final detection model if the first precision rate is greater than the second precision rate, and
the second detection model is selected as the final detection model if the second precision rate is greater than the first precision rate; and
inputting detection data into the final detection model to obtain a detected result of the detection data.

2. The method of claim 1, wherein the predetermined neural network is a convolutional neural network, and amount of data for the training set is greater than amount of data for the test set.

3. The method of claim 1, wherein the method of cleaning the training set and cleaning the test set according to one or more selected cleaning methods comprises:
obtaining one or more cleaning methods selected from a data cleaning library; and
cleaning the training set and cleaning the test set according to the one or more cleaning methods which are selected;
wherein the data cleaning library comprises a plurality of cleaning methods.

4. The method of claim 3, wherein the data cleaning library comprises a plurality of data cleaning units, each data cleaning unit corresponds to one data type, and the method further comprises:
obtaining a data type corresponding to the sample data; and
outputting a selection suggestion of the data cleaning units based on the data type corresponding to the sample data.

5. The method of claim 1, wherein the method of adjusting the first detection model by a predetermined rule comprises:
adjusting a model parameter of the first detection model by the predetermined rule.

6. The method of claim 5, wherein the model parameter comprises a number of hidden layers of the first detection model and a number of nerve cells of each hidden layer.

7. The method of claim 5, wherein the model parameter comprises a number of hidden layers of the first detection model or a number of nerve cells of each hidden layer.

8. The method of claim 1, further comprising:
obtaining a data type corresponding to the sample data;
obtaining cleaning methods of the data type recorded in a historical cleaning record; and
defining multiple cleaning methods that have been most often selected as a predetermined number in the historical cleaning record as suggested cleaning methods.

9. The method of claim 1, wherein the sample data comprises simple images, the one or more selected cleaning methods are selected from the group consisting of: image feature extracting, background removal, noise suppression, and smoothing.

10. A data processing device comprising:
at least one processor;
a storage device; and
one or more programs that are stored in the storage and executed by the at least one processor, the one or more programs comprising instructions for:
dividing, by the processor, sample data into a training set and a test set;
training, by the processor, a predetermined neural network to obtain a first detection model based on the training set;
testing the first detection model based on the test set and counting a first precision rate based on the testing of the first detection model, by the processor;
cleaning the training set and cleaning the test set according to one or more selected cleaning methods, by the processor;
adjusting the first detection model by a predetermined rule and training the first detection model that has been adjusted based on the training set that has been cleaned to obtain a second detection model, by the processor;
testing the second detection model based on the test set that has been cleaned and counting a second precision rate based on the testing of the second detection model, by the processor;
determining, by the processor, whether the first precision rate is greater than the second precision rate, wherein
the first detection model is selected as a final detection model if the first precision rate is greater than the second precision rate, and
the second detection model is selected as the final detection model if the second precision rate is greater than the first precision rate; and
inputting, by the processor, detection data into the final detection model to obtain a detected result of the detection data.

11. The device of claim 10, wherein the predetermined neural network is a convolutional neural network, and amount of data for the training set is greater than amount of data for the test set.

12. The device of claim 10, wherein the instruction of cleaning the training set and cleaning the test set according to one or more selected cleaning methods comprises:
obtaining one or more cleaning methods selected from a data cleaning library; and
cleaning the training set and cleaning the test set according to the one or more cleaning methods which are selected;
wherein the data cleaning library comprises a plurality of cleaning methods.

13. The device of claim 12, wherein the data cleaning library comprises a plurality of data cleaning units, each data cleaning unit corresponds to one data type, and the method further comprises:
obtaining a data type corresponding to the sample data; and
outputting a selection suggestion of the data cleaning units based on the data type corresponding to the sample data.

14. The device of claim 10, wherein the method of adjusting the first detection model by a predetermined rule comprises:
adjusting a model parameter of the first detection model by the predetermined rule.

15. The device of claim 14, wherein the model parameter comprises a number of hidden layers of the first detection model and a number of nerve cells of each hidden layer.

16. The device of claim 14, wherein the model parameter comprises a number of hidden layers of the first detection model or a number of nerve cells of each hidden layer.

17. The device of claim 10, wherein the one or more programs further comprise:
obtaining a data type corresponding to the sample data;
obtaining cleaning methods of the data type recorded in a historical cleaning record; and
defining multiple cleaning methods that have been most often selected as a predetermined number in the historical cleaning record as suggested cleaning methods.

18. The device of claim 10, wherein the sample data comprises simple images, the one or more selected cleaning methods are selected from the group consisting of: image feature extracting, background removal, noise suppression, and smoothing.
